(19) United States
(12) Patent Application Publication
(10) Pub. No.: US 2026/0269482 A1
(43) Pub. Date: Sep. 10, 2026

(54) SUBSTRATE-INTEGRATED DIELECTRIC WAVEGUIDE ANTENNA

(71) Applicant: HUAWEI TECHNOLOGIES CO., LTD., SHENZHEN (CN)

(72) Inventor: Huanhuan GU, Kanata (CA)

(73) Assignee: HUAWEI TECHNOLOGIES CO., LTD., SHENZHEN (CN)

(21) Appl. No.: 19/070,253

(22) Filed: Mar. 4, 2025

(51) Int. Cl. H01Q 13/02

(52) U.S. Cl. CPC H01Q 13/02

(57) ABSTRACT

An antenna unit for transmission of a signal is provided. The antenna unit includes a substrate-integrated antenna having an inner portion surrounded by an outer layer having lower permittivity as a result of being physically structured using discontinuities, holes, or metal vias. The antenna is coupled to a substrate-integrated waveguide at one end and configured for coupling to a connections waveguide at another end. One end of the antenna waveguide has a height and width greater than the other end. Antenna units can be integrated into an antenna module where antenna units are arranged side by side, on top of each other, or both.

### CROSS-REFERENCE TO RELATED APPLICATIONS

This is the first application filed for the present disclosure.

### FIELD OF THE INVENTION

The present disclosure pertains to the field of integrated circuit components, and in particular to a substrate-integrated dielectric waveguide antenna apparatus.

### BACKGROUND

Rapidly growing traffic in data centers (e.g., pertaining to Artificial Intelligence (AI), Internet of Things, big data, 3rd Generation Partnership Project (3GPP) 5th generation (5G) networks, self-driving cars, etc.) highlights the need for high-speed, low-cost and more efficient interconnects transmission links for datacenters and computing. Utilization of dielectric waveguide and substrate integrated waveguide (SIW) components in integrated circuits has the potential to offer lower signal propagation loss and lower power consumption compared to other technologies, such as copper cable-based components, photonic components and wireless components.

Ease of integration, compactness and scalability of various networking hardware components, such as interconnects, transceivers and antennas, are desirable features for successful deployment and adaptation to technological advancements, such as rapid growth and adaptation of AI, that increases demand for high-speed computing data centers having bigger bandwidth, lower power consumption and higher data transmission capabilities.

Therefore, there is a need for apparatuses and methods that obviate or mitigate one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

One or more aspects of disclosure provides for systems and methods for a substrate-integrated dielectric antenna, antenna unit, and antenna module.

According to implementations, there is provided a substrate-integrated dielectric waveguide antenna (SIDWA). The SIDWA includes an antenna structure A(S) that includes a first AS end configured to couple to a substrate-integrated dielectric waveguide, a second AS end, and an inner portion (IP) extending from the first AS end to the second AS end. The IP has a first permittivity. The IP has a first IP transverse dimension, a second IP transverse dimension, a first IP end formed at the first AS end, and a second IP end formed at the second AS end and opposite the first IP end. The first IP transverse dimension is smaller, at the first IP end, than the first IP transverse dimension at the second IP end. The second IP transverse dimension is smaller, at the first IP end, than the second IP transverse dimension at the second IP end. The AS has an outer layer that has a second permittivity, the second permittivity being less than the first permittivity, the outer layer surrounding the IP of the AS.

According to an implementation, the first transverse dimension may align with an H-plane of the EM signal and the second transverse dimension may align with an E-plane of the EM signal.

According to an implementation, the second transverse dimension may be larger, smaller or same as the first transverse dimension.

According to an implementation, the second transverse dimension at the second IP end may be larger, smaller or same as the first transverse dimension at the second IP end.

According to an implementation, the IP may include a dielectric material, and the outer layer may include a same dielectric material as that of the IP. The dielectric material of the outer layer may define a plurality of discontinuities causing the permittivity of the outer layer to be lower than the permittivity of the IP.

According to an implementation, the SIDWA may include a dielectric substate having the AS is defined therein.

According to an implementation, the IP may include a dielectric material that is at least one of continuous, evenly distributed, and homogeneous. The outer layer may include a same dielectric material as that of the IP. The dielectric material of the outer layer may define a pattern of openings that causes the permittivity of the outer layer to be lower than the permittivity of the IP.

According to an implementation, the IP of the antenna structure may include a dielectric material that is at least one of continuous, evenly distributed, and homogeneous. The outer layer may include a same dielectric material as that of the IP of the antenna structure. The dielectric material of the outer layer may define a plurality of holes that cause the permittivity of the outer layer to be lower than the permittivity of the IP of the antenna structure.

According to an implementation, the dielectric material may include alumina.

According to an implementation, the IP may define a flared section wherein at least one the first IP transverse dimension and the second IP transverse dimension increases perpendicularly to a direction from the first IP end to the second IP end.

According to an implementation, the first transverse dimension and the second transverse dimension may define a rectangular waveguiding section.

According to implementations, there is provided an antenna module. The antenna module includes a plurality of antenna units, each antenna unit of the plurality of antenna units has a substrate-integrated waveguide (SIW) having a first SIW end configured to couple to an integrated circuit (IC) and a second SIW end. Each antenna unit has a substrate-integrated antenna (SIA) having a first SIA end coupled to the second SIW end and a second SIA end, wherein least one of: the second SIA ends of all the SIAs are in a first common plane, and the first SIW ends of all the SIWs are in a second common plane.

According to an implementation, the SIA of each antenna unit of the plurality of antenna units may include a respective antenna structure (AS). The AS may include an inner portion (IP) having a first permittivity. The IP may have a first IP transverse dimension, a second IP transverse dimension, a first IP end formed at the first SIA end of the respective SIA, and a second IP formed at the second SIA end and opposite the first IP end. The first IP transverse dimension may be smaller, at the first IP end, than the first IP transverse dimension at the second IP end. The second IP transverse dimension may be smaller, at the first IP end, than the second IP transverse dimension at the second IP end. The AS may include an outer layer having a second permittivity, the second permittivity being less than the first permittivity, the outer layer surrounding the IP of the AS.

According to an implementation, the SIA of an antenna unit of the plurality of antenna units may be contiguous to the SIA of at least one different antenna unit of the plurality of antenna units.

According to an implementation, the plurality of antenna units may be comprised of M by N antenna units having associated thereto M by N second SIA ends, M and N being positive integer numbers, and the M by N second SIA ends may be arranged in a matrix, in the first common plane.

According to an implementation, the plurality of antenna units may be comprised of M by N antenna units having associated thereto M by N first SIW ends, M and N being positive integer numbers, and the M by N first SIW ends are arranged in a matrix, in the second common plane.

According to an implementation, for each SIA, the IP of the respective AS may include a dielectric material that is at least one of continuous, evenly distributed, and homogeneous. The outer layer of the respective AS may include a same dielectric material as that of the IP of the AS. The dielectric material of the outer layer may define a plurality of discontinuities causing the permittivity of the second layer to be lower than the permittivity of the antenna structure.

According to an implementation, for each SIA, the IP of the respective AS may include a dielectric material that is at least one of continuous, evenly distributed, and homogeneous. The outer layer of the respective AS may include a same dielectric material as that of the IP of the AS. The dielectric material of the outer layer may define a pattern of openings that causes the permittivity of the outer layer to be lower than the permittivity of the inner portion of the antenna structure.

According to an implementation, the SIA may be one of a substrate integrated waveguide antenna (SIWA), the outer layer comprising a metal, and a substrate integrated dielectric waveguide antenna (SIDWA).

According to implementations, there is provided a substrate-integrated antenna unit. The antenna unit includes a substrate-integrated dielectric waveguide (SIDW) having a first SIDW end and a second SIDW end, the first SIDW end being configured to couple to an integrated circuit. The antenna unit includes a substrate-integrated dielectric waveguide antenna (SIDWA) having a first SIDWA end and a second SIDWA end. The first SIDWA end is coupled to the second SIDW end, and the second SIDWA end is configured to couple to a wave propagating structure. The SIDWA has a physically patterned substrate portion. The SIDWA has an un-patterned substrate portion extending from the first SIDWA end toward the second SIDWA end. The un-patterned substrate portion has a flared section. The physically patterned substrate portion surrounds the un-patterned substrate portion and is configured to confine, in the un-patterned substrate portion, an electro-magnetic (EM) signal as the EM signal propagates between the first SIDWA end and the second SIDWA end.

According to an implementation, the antenna unit may include a substrate that includes the SIDWA. The physically patterned substrate portion may define a pattern of holes in the substrate.

According to an implementation, a width of the flared section may increase in a direction from the first SIDWA end toward the second SIDWA end.

According to an implementation, the un-patterned substrate portion may have rectangular waveguiding section coupled to the flared section.

Implementations have been described above in conjunction with aspects of the present disclosure upon which they can be implemented. Those skilled in the art will appreciate that implementations may be implemented in conjunction with the aspect with which they are described but may also be implemented with other implementations of that aspect. When implementations are mutually exclusive, or are incompatible with each other, it will be apparent to those skilled in the art. Some implementations may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 shows a schematic illustration of an example all-to-all data center architecture, according to the prior art.

FIG. 2 shows a schematic illustration of a device that can utilize a dielectric waveguide antenna, according to an implementation of the present disclosure.

FIG. 3 shows a perspective view of an antenna unit, according to an implementation of the present disclosure.

FIG. 4 shows a cross-sectional view of the antenna unit of FIG. 3.

FIG. 5 shows an example of a plot of a reflection coefficient as a function of signal frequency the antenna unit of FIG. 3.

FIG. 6 shows a cross-sectional view of an antenna unit, according to an implementation of the present disclosure.

FIG. 7 shows a cross-sectional view of an antenna unit according to another implementation of the present disclosure.

FIG. 8 shows a top, view of a simulation of a signal transmission across an antenna unit, according to an implementation of the present disclosure.

FIG. 9 shows a side, view of a simulation of a signal transmission across an antenna unit, according to an implementation of the present disclosure.

FIG. 10A shows a top cross-sectional view of the antenna of FIG. 3 coupled to a connections waveguide, according to an implementation of the present disclosure.

FIG. 10B shows a top cross-sectional view of a simulation of a signal transmission across an antenna unit with a connections waveguide coupled thereto, according to an implementation of the present disclosure.

FIG. 10C shows a plot of a transmission coefficient as a function of frequency for the antenna unit of FIG. 10A, according to an implementation of the present disclosure.

FIG. 11A shows a top cross-sectional view of an antenna module, according to an implementation of the present disclosure.

FIG. 11B shows a top cross-sectional view of a simulation of a signal transmission across the antenna unit 300a of the antenna module of FIG. 11A, according to an implementation of the present disclosure.

FIG. 11C shows a plot of a transmission coefficient as a function of frequency for an antenna unit of the antenna module of FIG. 11A, according to an implementation of the present disclosure.

FIG. 12A shows a side cross-sectional view of an antenna module, according to another implementation of the present disclosure.

FIG. 12B shows a side cross-sectional view of a simulation of a signal transmission across an antenna unit of the antenna module of FIG. 12A, according to an implementation of the present disclosure.

FIG. 12C shows a plot of a transmission coefficient as a function of frequency for an antenna unit of the antenna module of FIG. 12A, according to an implementation of the present disclosure.

FIG. 13 shows a side cross-sectional view of an antenna module having each antenna unit coupled to an integrated circuit (IC) of a printed circuit bard (PCB), according to an implementation of the present disclosure.

FIG. 14 shows a top perspective view of an implementation of another antenna module, according to an implementation of the present disclosure.

FIG. 15 shows a side perspective view of an implementation of another antenna module having each antenna unit thereof coupled to an IC of a PCB, according to an implementation of the present disclosure.

It will be noted that throughout the appended drawings, like features are identified by like reference numerals.

### DETAILED DESCRIPTION

The present disclosure provides an antenna, an antenna unit and method of use thereof for transmitting and receiving an electro-magnetic (EM) signal (also referred to herein as “signal”), such as, e.g., a radio frequency (RF) signal. The antenna unit includes an antenna (also referred to herein as a substrate-integrated antenna (SIA), e.g., substrate-integrated dielectric waveguide antenna (SIDWA) or a substrate-integrated waveguide antenna (SIWA)) that has an antenna structure (AS) that includes an antenna waveguide (also referred to herein as an inner portion of the antenna, e.g., un-patterned substrate portion) that is coupled to a substrate integrated waveguide (SIW) or a substrate-integrated dielectric waveguide (SIDW). The antenna unit and at least the inner portion of the antenna thereof define a flared shape (horn shape). The antenna has an outer layer (also referred to herein as a second portion) that (e.g., axially) surrounds the inner portion and has lower permittivity than the inner portion, which confines the EM signal within the inner portion of the antenna as the EM signal propagates therethrough, thereby limiting peripheral loss of the EM signal. Because of the reduced peripheral loss, antenna units can be arranged and integrated or formed side by side and/or on top of one another, relatively close to each other, to form an antenna module. Antenna units of the module may be arranged in a geometrical pattern such as a matrix pattern having M rows and N columns, offering scalability at low space requirements. The antenna module and units thereof can be suitably configured and integrated with printed circuit boards (PCBs) or integrated circuits (ICs).

The present disclosure sets forth various implementations via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples may be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in implementations” may be interpreted to mean “in one or more, but not necessarily all implementations.”

Data center topologies and other networking applications can require a substantial amount of interconnections. Such highly interconnected topologies (e.g., an all-to-all topology), can benefit from components, such as antennas, that are scalable and can be integrated with existing structures, such as printed circuit boards (PCBs).

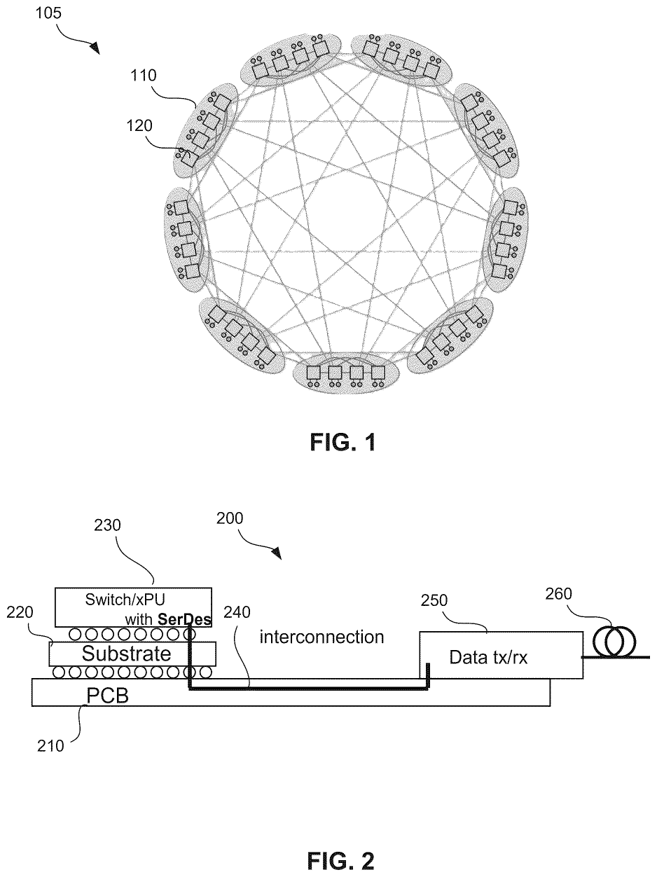

FIG. 1 shows a schematic illustration of an example all-to-all data center architecture 105, for high performance applications, such as Artificial Intelligence (AI) applications. The data center architecture 105 is known as a dragonfly topology and includes clusters 110 of multiple graphics processing units (GPUs) 120, where all of the clusters 110 and all the GPUs 120 are interconnected, and further connected to central processing units (CPUs).

FIG. 2 shows a schematic cross section of a device 200 that includes a PCB 210 having a substrate 220 thereon with a switch/processing unit 230 that includes a Serializer/Deserializer 230 connected, via an interconnection 240, to a data transmitter/receiver 250 (i.e., functioning as one or both of to transmit and receive a signal) that includes an antenna unit. The interconnection 240 is made through the substrate 220 and the PCB 210. The interconnection 240 may include a SIDW. In the present example, the transmitter/receiver 250 is a terahertz (THz) transceiver coupled to an external connection 260, which is or includes a waveguide (also referred to herein as connection waveguide, waveguide structure, wave propagating structure, interconnect).

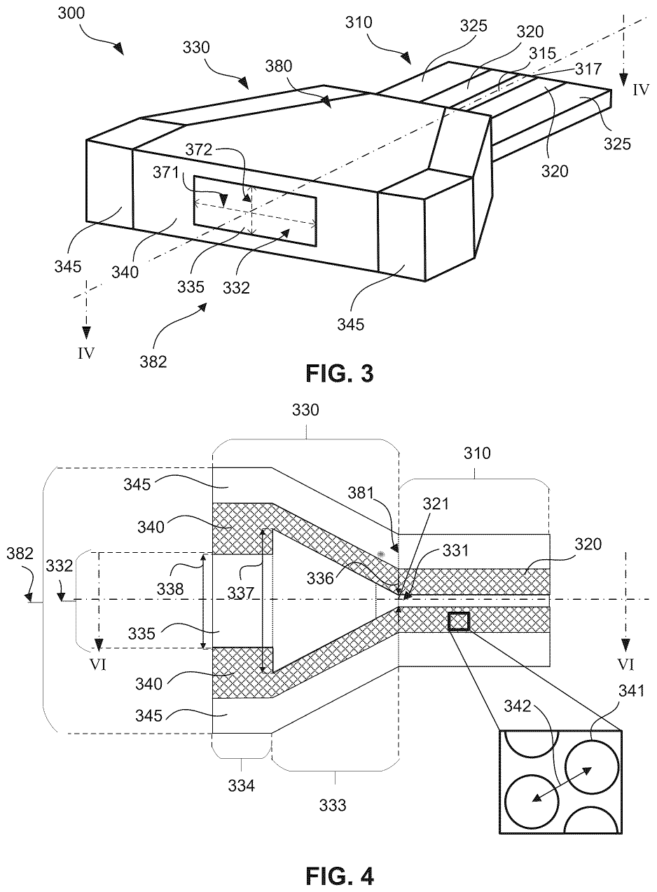

FIG. 3 shows a perspective view of an antenna unit 300, according to an implementation. The antenna unit 300 includes a substrate-integrated waveguide (e.g., SIW where the signal is confined using a plurality of metal vias, or a SIDW where the signal is confined using a material that has lower permittivity such as a patterned dielectric material or dielectric substrate) 310 that includes a waveguide portion 315 for signal propagation. The waveguide portion 315 is defined in a substrate 325 by a series of discontinuities 320 (e.g., holes, perforations, inhomogeneities, openings) defined in the substrate on either side of the waveguide portion 315. Where discontinuities 320 are hollow or air-filled, the SIW is an SIDW. In some implementations, the discontinuities 320 may be metallic vias and the SIW may be coated with a metal on top and bottom, resulting. The waveguide portion 315 is said to be integrated in the substrate 325 and is made of a generally same material as the substrate 315. The SIW 310 also includes a first end 317, configured to be coupled to an integrated circuit, and a second end 321 (shown in FIG. 4).

In implementations, the substrate is a dielectric material, such as alumina or any other suitable dielectric that can have a SIW or SIDW integrated or formed therein. The substrate is or can be integrated with a PCB.

As further shown in the implementation of FIG. 3, the antenna unit 300 includes an antenna 330 that is a substrate-integrated antenna (SIA). In one example implementation, the SIA may be a substrate-integrated waveguide antenna (SIWA) where the signal is confined using metal vias. In another example implementation, the SIA may be a substrate-integrated dielectric waveguide antenna (SIDWA) where the signal is confined by an outer layer that has lower permittivity facilitated using a plurality of discontinuities in a dielectric material that are generally hollow or air-filled. The antenna 330 is formed in a substrate and includes an antenna structure 380 that includes an inner portion (IP) 335 that is coupled to the waveguide portion 315 of the SIW 310 (the inner portion may also be referred to as being a first portion). The inner portion 335 has first IP end 331 (shown in FIG. 4) that may be configured (e.g., by having a suitable height and width that may match those of the waveguide portion 315 of the SIW) to be coupled or be coupled to a second SIW end 321 (shown in FIG. 4) and second IP end 332. Waveguide antennas that are substrate-integrated but that include material that is not dielectric material may be referred to as substrate-integrated waveguide antennas (SIWA).) Such SIWAs may, for example, have metal vias defined in a substrate to confine the signal and may have a top and bottom metal layers (not shown). The inner portion 335 includes an output section or a second end 332 that is or can be configured to (e.g., by a having a suitable height and width) to couple to a connection waveguide or optical interconnect (not shown). In the context of the present disclosure, a height or a second transverse dimension 372 and a width or a first transverse dimension 371 are transverse dimensions, i.e., dimensions transverse (e.g., perpendicular) to each other and generally perpendicular to an axial direction of the antenna between the first end 381 to the second end 382 thereof.

The antenna structure 380 includes an outer layer 340 (can also be referred to as a surrounding layer or as a second portion) that generally surrounds or encloses the lateral (radial) periphery of the inner portion 335 (i.e., the inner portion of the antenna structure 380). The antenna 330 may include substrate portions 345 on one or both sides of the second portion 340.

In implementations, the outer layer 340 has a lower permittivity than the inner portion 335. In some implementations, the inner portion may include or be made of a dielectric material (e.g., alumina) that is substantially homogenous, continuous, and/or evenly distributed. The outer layer may be made of a same dielectric material as the inner portion and include a physical pattern that makes the second portion inhomogeneous or having a plurality of holes, a pattern of openings, and/or a plurality of discontinuities that cause or at least contribute to the lower permittivity of the outer layer with respect to that of the inner portion 335. The physical pattern may be a pattern of holes (apertures, holes, openings, discontinuities, inhomogeneities). The outer portion causes confinement of an EM signal propagating through the antenna waveguide.

In implementations, the inner portion 335 of the antenna may be polarized having the electric component of the EM signal in an E-plane and the magnetic component of the EM signal in an H-plane. In some implementations, the H-plane may substantially align with the first transverse dimension 371 and the E-plane may substantially align with the second transverse dimension 372. In some implementations, the H-plane may substantially align with a larger transverse dimension (e.g., larger at the second IP end 332) of the two transverse dimensions of the IP, and the E-plane may substantially align with a smaller transverse dimension (e.g., smaller at the second IP end 332) of the two transverse dimensions of the IP. Typically, when the larger side with the larger transverse dimension is aligned with the electric or magnetic components of the EM field of the EM signal, a corresponding E-flare or H-flare, respectively, is produced. For example, when the larger transverse dimension, e.g., the first transverse dimension 371 is larger, aligns with H field, then such IP and the antenna may be referred to as being H-flared or as a sectoral H-plane horn antenna. In another example, when the larger transverse dimension aligns with E field, e.g., if the second transverse dimension 372 were larger than the first transverse dimension 371 at the second IP end 332 (not shown), then such IP and the antenna may be referred to as being E-flared or as a sectoral E-plane horn antenna. More generally, as described herein, the IP can be flared in both first and second transverse dimensions, with flaring in one transverse dimension being larger than the flaring in the other transverse dimension. In some implementations, the flaring in both transverse dimensions may be the same, for example to suit a particular application of the antenna.

Referring to FIG. 4, which is a cross-sectional view of the antenna unit 300, in the direction identified by the line IV-IV in FIG. 3, the outer layer 340 may include a plurality of holes 341 (e.g., holes, perforations, discontinuities). Holes 341 may have a circular cross section and have a generally cylindrical profile. In other cases, holes may have any suitable cross section and profile based on one or more of: facilitating suitable confinement of the signal in the inner portion of the antenna, selected material(s) for the outer layer, and selected fabrication method for the holes. Holes may be arranged in a repeating pattern, for example a hexagonal pattern. Distance 342 between centers of adjacent holes may be constant for all adjacent holes or may vary, for example depending on the repeating pattern. In some implementations, the diameter of the holes may be 0.0625 mm and the center-to-center distance between the holes may be 0.15 mm. As will be understood by the skilled worker, any other suitable values may be used.

In implementations, the holes 341 may be similar to the discontinuities 320. For example, if the discontinuities 320 are metal vias, then the holes 341 of the outer layer 340 are similarly metal vias. In another example, in the discontinuities 320 are hollow or air-filled, then the holes 341 of the outer layer 340 are similarly hollow or air filled, resulting in the SIA being a SIDWA.

In implementations, the inner portion of the antenna and the SIW may be comprised of or may include a same dielectric material and may have a same permittivity. Substrate portions of the antenna may be made of or may include a same dielectric material as the substrate of the SIW.

In some implementations, the antenna and the SIW may be made of or may include the same dielectric material, while having some portions physically structured, such as the regions of holes of SIW and the outer layer of the antenna. Such configurations support integration of the antenna with the SIW by advantageously utilizing same materials, same fabrication techniques (e.g., etching, drilling to make holes, using alumina as a starting material, using metal vias and top and bottom metal layers, etc.), or both.

The antenna 330, or at least the inner portion thereof, includes a widening portion 333 (also referred to herein as a flared section) that has a width increasing perpendicularly to a direction from the first IP end 331 to the second IP 332. In other words, the first IP transverse dimension 371 is smaller at the first IP end 331 than at the second IP end 332. The width may increase in any suitable manner (e.g., linearly, exponentially, in steps, etc.) from the first IP end 331 of the AS 380 to have a wide section width 337 where it is coupled to a straight section 334 (also referred to herein as a rectangular waveguiding section coupled to the flared section and extending to the second end of the AS). The inner portion 335 has a width 336 at the first IP end 331. The straight section 334 has a straight section width 338 and spans from the widening section 333 to the second IP 332. The straight section width may be less than the wide section width, for example to facilitate signal confinement within the inner portion and decrease or limit signal loss.

In implementations, the widening section is provided to facilitate signal coupling, signal propagation, or both, between the antenna and the SIW. The widening section is also provided to facilitate coupling of the second IP end of the AS with a connection waveguide which generally has larger cross section (e.g., width, height, diameter) than the SIW. The straight section is provided to facilitate signal confinement within the inner portion of the AS, to facilitate coupling to the connection waveguide (e.g., by being sized accordingly), or both.

As further shown in FIG. 4, the outer layer 340 of the AS 380 may be coupled to the regions of holes 320 of the SIW, may share a boundary therewith, or may be at least partially contiguous therewith.

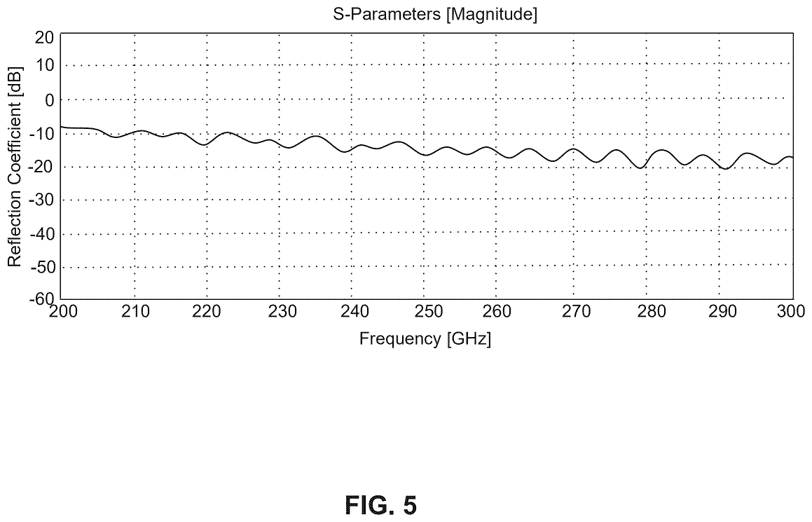

FIG. 5 shows an example of a plot of a reflection coefficient as a function of signal frequency for the antenna unit of FIG. 3 where the SIW is an SIDW and the SIA is an SIDWA, from 200 GHz to 300 GHz, crossing a bandwidth of at least 100 GHz.

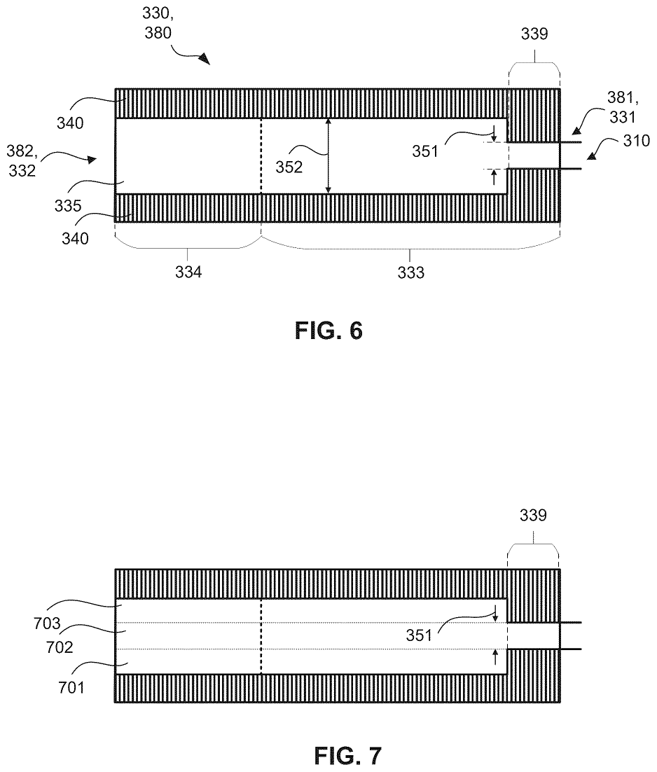

FIG. 6 shows a cross-sectional view of the antenna 330, in the direction identified by the line VI-VI in the implementation shown at FIG. 4. The inner portion 335 includes a transition region 339 that has a constant height 351 (or constant second transverse dimension 372) at least for a portion of the region immediately adjacent to the first IP end 331 that is coupled to the waveguide portion of the SIW 310. The transition region 339 is a part of the widening region 333. In the transition region, the inner portion 335 has a width (or the first transverse dimension 371) that increases from the first IP end 331 towards the straight section 334, while having a constant height 351 (or constant second transverse dimension 372) as described, which contributes to coupling of the signal between the inner portion 335 and waveguide portion of the SIW 310.

The remaining portion of the inner portion of the antenna between the transition region 339 and the second IP end 332 may have a substantially constant height 352 (or constant second transverse dimension 372) that may be dimensioned for coupling to the connection waveguide (not shown).

In implementations, the antenna or at least the inner portion thereof may include a plurality of layers. Layers may be a result of fabrication methods used in PCB fabrication, for example. In a non-limiting example, a fabrication step may involve depositing or forming a layer of the antenna to form at least a part of the inner portion, then physically structuring (e.g., drilling, etching, perforating, etc.) a portion or region(s) of this layer to obtain lower permittivity or another property facilitating signal confinement within the antenna waveguide. A subsequent deposited or formed layer may be fully physically structured, for example to form a part of the outer layer of the antenna that substantially covers the preceding layer. Layers of the inner portion may be made of a same dielectric and have same permittivity, or may have respective permittivity values, for example to facilitate or contribute to signal confinement, propagation, or both. A layer may be made of or may include alumina, silicon, polytetrafluoroethylene (PTFE), etc. The plurality of layers may include a middle layer that has a height that matches the height of the transition region of the antenna that has a constant height. Layers may have a uniform height or thickness. Some or all of the layers may be formed jointly with the SIDW or SIW, for example at least the middle layer(s) that couples to the waveguide portion of the SIDW or SIW.

FIG. 7 shows a cross-sectional view of a different implementation of antenna unit. In the implementation of FIG. 7, the inner portion of the antenna includes three layers: bottom layer 701, middle layer 702 and top layer 703. The middle layer 702 has a same height as the constant height 351 portion of the transition region 339. The bottom layer 701 and the top layer 703 have respective heights or thicknesses that may be the same or may be different from each other or from the height or thickness of the middle layer 702.

In some implementations, transitions between layers or regions, in height, width or both, may be relatively abrupt, for example as illustrated in FIGS. 6 and 7 where a transition of about 90 degrees between the transition region 339 and the remainder of the antenna is shown. In other implementations, such transitions may be gradual and may be generally suited to facilitate one or more of signal confinement, signal coupling, lower signal loss, and signal propagation. Additionally, or alternatively, transitions may depend on specific fabrication methods. In some cases, one or more of signal confinement, signal coupling, signal loss, and signal propagation, and one the fabrication and SIDW or SIW integration may be considered in choosing suitable transitions between different regions and sections of the antenna.

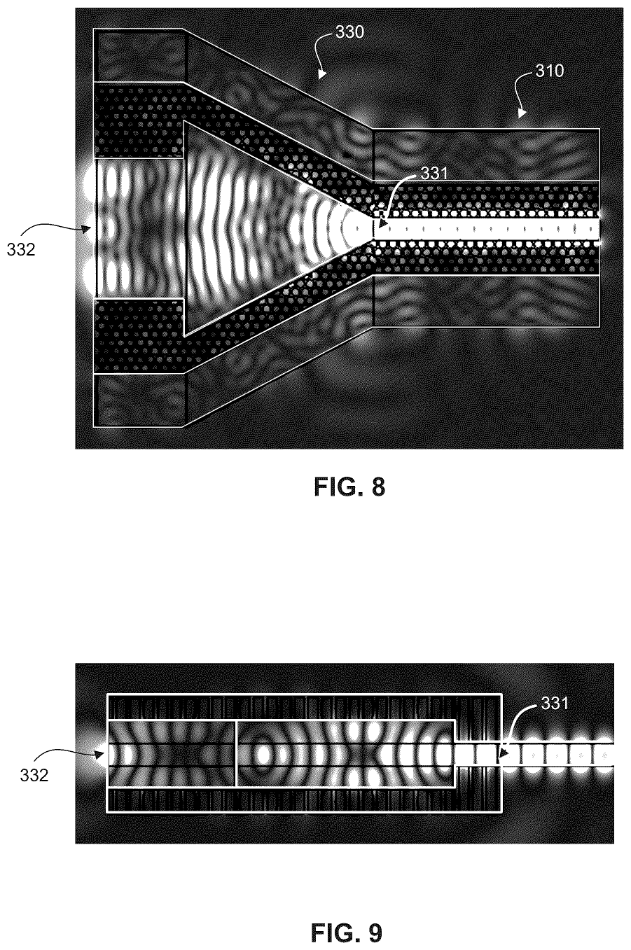

FIGS. 8 and 9 show top and side cross sectional views, respectively, of a simulated signal transmission from the SIDW 310 through the antenna 330 to the output section 332 thereof.

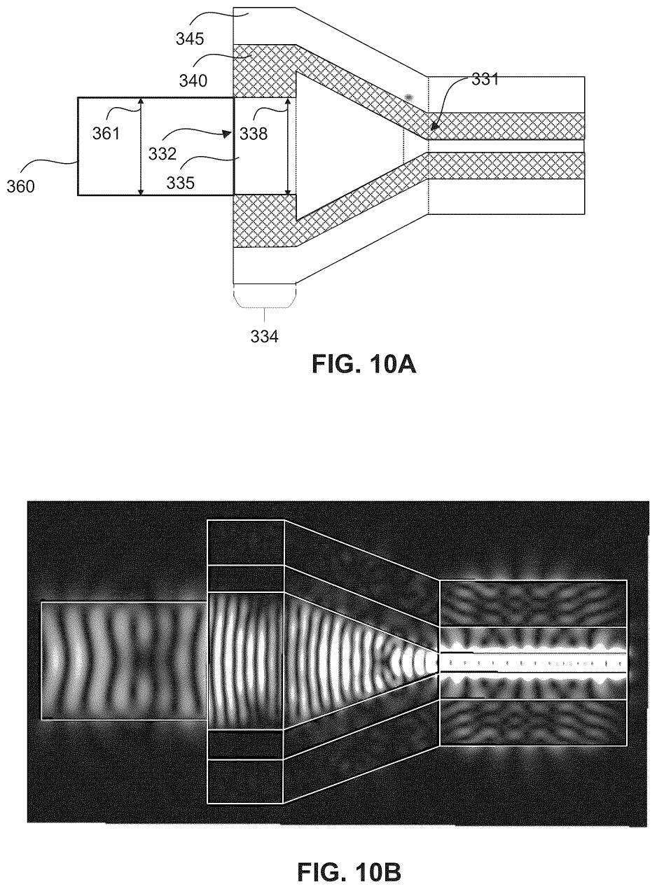

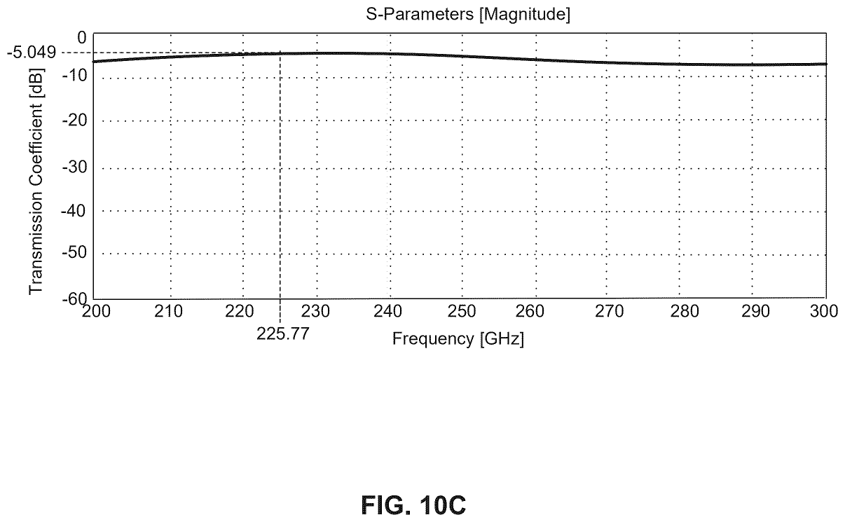

FIG. 10A shows a schematic of the top cross section of the antenna unit 300 of FIG. 3 with the connection waveguide 360 coupled to the output section 332 of the antenna 330, according to an implementation. The width 361 of the connection waveguide 360 may be substantially same as the width 338 of the straight portion 334 of the antenna waveguide, for example to facilitate propagation of the signal therebetween.

FIG. 10B shows simulated signal transmission from the SIDW to the antenna waveguide and further to the connection waveguide.

In implementations, dimensions (height, width, diameter, etc., depending on cross-section) of the output section of the antenna may be suited or selected accordingly to facilitate or optimize signal propagation between the antenna and the connection waveguide.

In implementations, the cross section of the inner portion of the antenna at the output section thereof may be generally rectangular, as described herein with reference to the exemplary implementations shown at FIGS. 3, 4, 6, and 7. More generally, at least the inner portion of the antenna at the output section thereof may have any cross section suitable for coupling to the connection waveguide or a connection component thereof, for example, rectangular, square, circular, double circular, tubular, etc.

In implementations, the connection waveguide may have a cross section and size of a typical dielectric waveguide used in various interconnects known in the art, such as rectangular, square, circular, double circular, tubular, etc. The connection waveguide may be made of a suitable dielectric material, such as high-density polyethylene (HDPE), polytetrafluoroethylene (PTFE), etc.

In implementations, an antenna module is provided and includes a plurality of antenna units that may be arranged in a geometrical pattern such as a matrix pattern having M rows and N columns, where M and N are positive integers. The plurality of antenna units includes at least two antenna units that are adjacent each other, such than an antenna unit of the antenna module is adjacent at least one other antenna unit of the antenna module. The adjacent antenna units may be side by side or may be on top of each other, either in substantially full or partial alignment. Antennas of adjacent antenna units may be contiguous, may share a boundary, may be integrated or jointly formed. Outer layers of adjacent antenna units, at least in part and in respective adjacent regions, and, if applicable, the substate portions of adjacent antenna units, may be shared, joined, integrated, or contiguous, can be configured based on one or more of: dimensional requirements for the antenna module, size requirements for the antenna module, required distance between the adjacent antenna units of the antenna module, suitable confinement of the propagating signal within each inner portion of the antenna, and minimizing interference between propagating signals of adjacent antenna units.

In implementations, respective output sections of (or second ends 382) antennas of the antenna module may be in a common plane. The output sections may be arranged in a matrix having M rows and N columns in a first common plane. In implementations, a plurality of antenna units may be comprised of M by N antenna units having associated thereto M by N second SIA ends (382), and the M by N second SIA ends may be arranged in a matrix, in the first common plane.

In implementations, respective first ends (317) of SIWs or SIDWs of the antenna module may be in a common plane. The output sections may be arranged in a matrix having M rows and N columns in a second common plane. The first and the second common plane may be substantially parallel. In implementations, a plurality of antenna units may be comprised of M by N antenna units having associated thereto M by N first SIW ends (317), and the M by N first SIW ends may be arranged in a matrix, in the second common plane.

FIG. 10C shows a plot of a transmission coefficient as a function of frequency for the antenna unit of FIG. 10A, according to an implementation of the present disclosure.

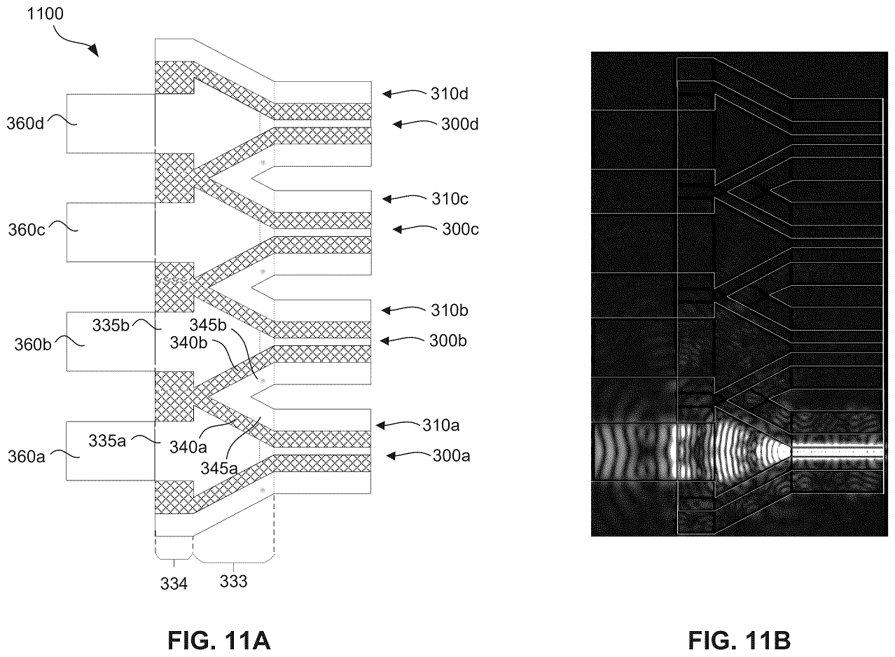

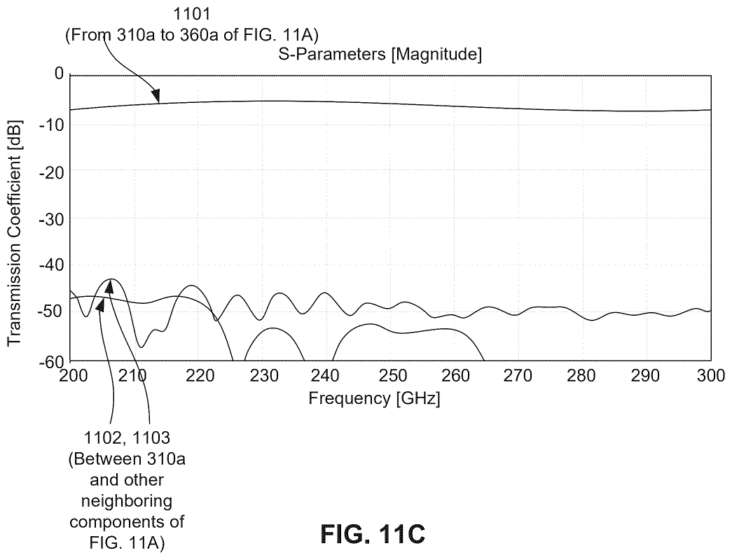

FIG. 11A shows a top cross-sectional view of an antenna module 1100 that includes four antenna units (300a, 300b, 300c, and 300d) arranged side by side, each having respective SIDWs (310a, 310b, 310c, and 310d) and respective connection waveguides (360a, 360b, 360c, and 360d). Adjacent antenna units, such as antenna units 300a and 300b, of the antenna module 1100 share portions of their respective second portions or outer layers, such as second portions or outer layers 340a and 340b, and also share portions of their respective adjacent substrate portions 345a and 345b.

FIG. 11B shows simulated signal transmission from an SIW of the antenna unit 3000a of FIG. 11A to the antenna waveguide 335a and further to the connection waveguide 360a.

FIG. 11C shows a plot of a transmission coefficient as a function of frequency between selected components of the antenna module of FIG. 11A, according to an implementation of the present disclosure. As shown, transmission 1101 from SIDW 310a to the connection waveguide 360a of the antenna unit 300a is relatively constant across the bandwidth, while transmissions 1102, 1103 from the SIDW 310a to components of other antenna units of the module 1100 are substantially low, indicating low leakage of the signal between adjacent antenna units of the module and significant isolation of the signal within an antenna unit.

In some implementations, adjacent outer layers of adjacent antenna unit arranged on top of each other may share a boundary. In other implementations, such adjacent outer layers may be, at least in part, shared, such that the combined height or thickness of adjacent outer layers is less than the sum of two individual outer layers that may simply share a boundary. Such combined height or thickness can be configured based on one or more of: dimensional requirements for the antenna module, size requirements for the antenna module, required distance between the adjacent antenna units of the antenna module, suitable confinement of the propagating signal within each antenna, and minimizing interference between propagating signals of adjacent antenna units.

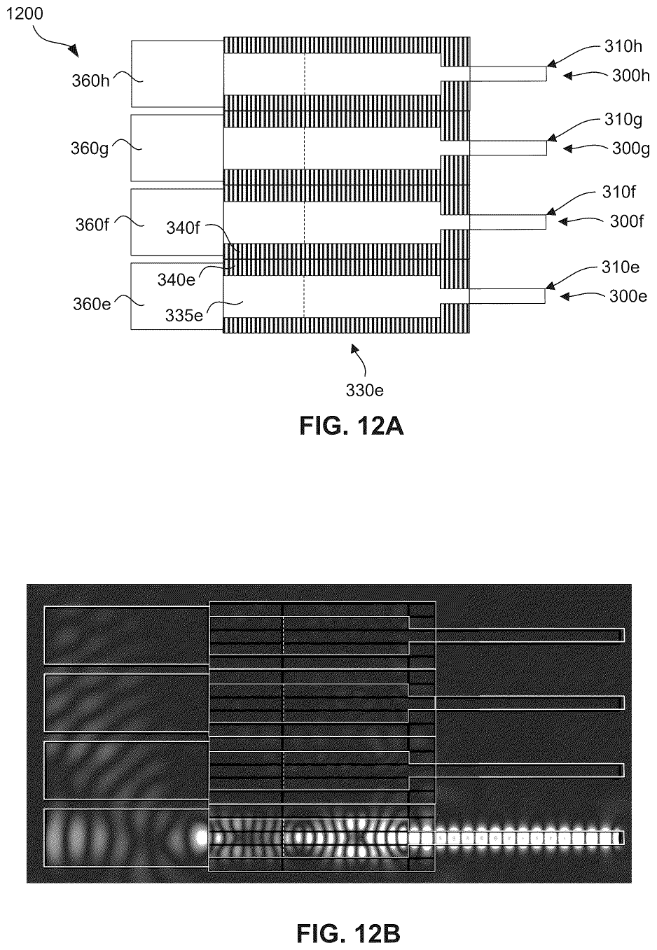

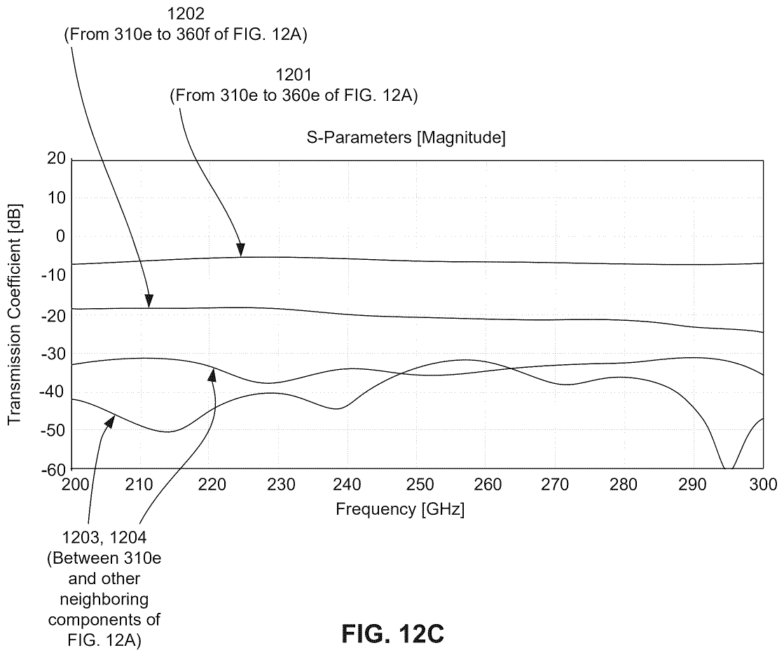

FIG. 12A shows a schematic of a side cross section of an antenna module 1200 that includes four antenna units (300e, 300f, 300g, and 300h) arranged on top of each other, each having respective SIDWs (310e, 310f, 310g, and 310h) and respective connection waveguides (360e, 360f, 360g, and 360h). Adjacent antenna units, such as antenna units 300e and 300f, of the antenna module 1200 share at least portions of their respective second portions or outer layers, such as second portions or outer layers 340e and 340f.

FIG. 12B shows a simulated signal transmission from an SIW of the antenna unit 300e of FIG. 12A to the antenna waveguide 335e and further to the connection waveguide 360e.

FIG. 12C shows a plot of a transmission coefficient as a function of frequency between selected components of the antenna module 1200 of FIG. 12A, according to an implementation of the present disclosure. As shown, transmission 1201 from SIDW 310e to the connection waveguide 360e of the antenna unit 300e is relatively constant across the bandwidth, while the transmission 1202 from SIDW 310e of the antenna unit 300e to the connection waveguide 360f of the adjacent antenna unit 300f, and transmissions 1203, 1204 between the SIDW 310e to components of other antenna units of the module 1200 are substantially low, indicating low leakage of the signal between adjacent antenna units of the module and significant isolation of the signal within an antenna unit.

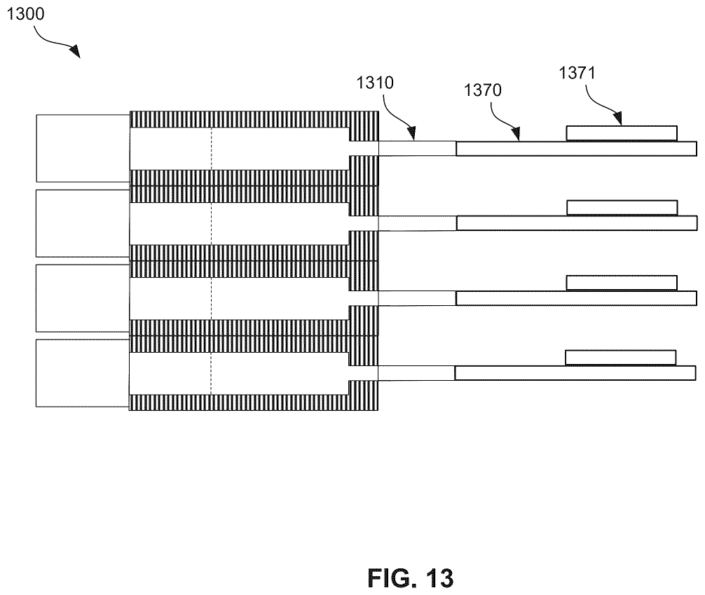

FIG. 13 shows a schematic of an antenna module 1300 comprising a plurality of SIWAs or SIDWAs where each SIW or SIDW 1310, respectively, is integrated with a PCB 1370 and coupled to an integrated circuit (IC) 1371, according to an implementation.

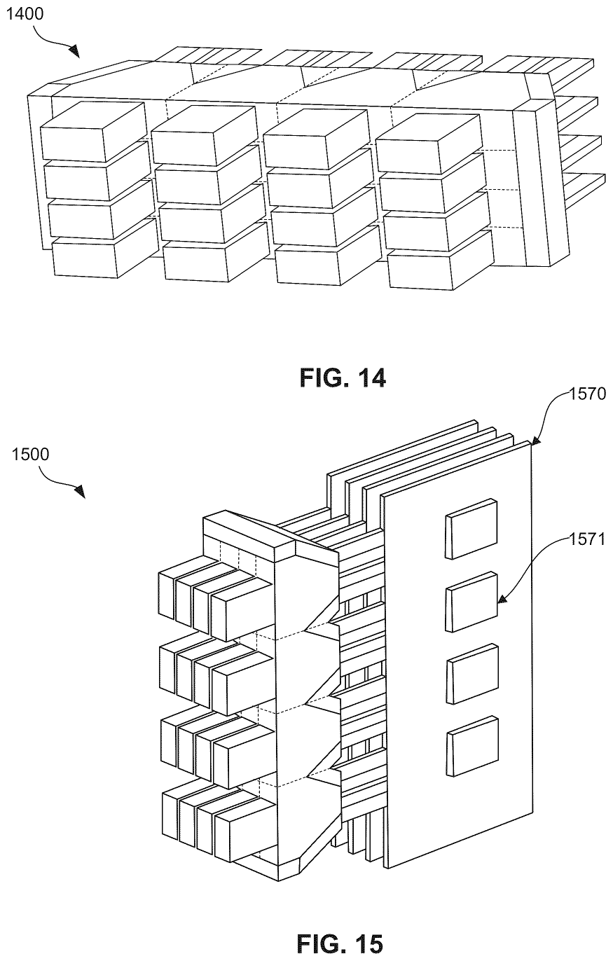

FIG. 14 shows a schematic of an antenna module 1400 that includes a plurality of antenna units arranged in a 4 by 4 geometric matrix pattern, according to an implementation.

FIG. 15 shows a schematic of an antenna module 1500 that includes a plurality of antenna units arranged in a 4 by 4 geometric matrix pattern, according to an implementation. Each row of adjacent antenna units is integrated with a respective same PCB 1570 and each SIW is coupled to a respective IC 1571 for each respective antenna unit.

In some implementations, an antenna module may include SIWA-based antenna unit and SIDWAs-based antenna units, for example arranged in stacked rows, such that a first row is comprised of SIWAs coupled to respective SIWs, and a second row on top of the first row is comprised of SIDWAs coupled to respective SIDWs. Other similar SIA and SIW configurations may be implemented in an antenna module, as described herein.

It will be appreciated that, although specific implementations of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated implementations, not all of them need to be combined to realize the benefits of various implementations of this disclosure. In other words, a system or method designed according to an implementation of this disclosure will not necessarily include all features shown in any one of the Figures or all portions schematically shown in the Figures. Moreover, selected features of one example implementation may be combined with selected features of other example implementations.

Although the present disclosure has been described with reference to specific features and implementations thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A substrate-integrated dielectric waveguide antenna (SIDWA), comprising:
an antenna structure (AS), the AS having:
a first AS end configured to couple to a substrate-integrated dielectric waveguide (SIDW);
a second AS end;
an inner portion (IP) extending from the first AS end to the second AS end, the IP having:
a first permittivity:
a first IP transverse dimension;
a second IP transverse dimension;
a first IP end formed at the first AS end; and
a second IP end formed at the second AS end and opposite the first IP end,
the first IP transverse dimension being smaller, at the first IP end, than the first IP transverse dimension at the second IP end; and
the second IP transverse dimension being smaller, at the first IP end, than the second IP transverse dimension at the second IP end;
and
an outer layer having a second permittivity, the second permittivity being less than the first permittivity, the outer layer surrounding the IP of the AS.

2. The SIDWA of claim 1, wherein the first transverse dimension aligns with a H plane and the second transverse dimension aligns with an E plane.

3. The SIDWA of claim 1, wherein:
the IP includes a dielectric material; and
the outer layer comprises a same dielectric material as that of the IP, the dielectric material of the outer layer defining a plurality of discontinuities causing the permittivity of the outer layer to be lower than the permittivity of the IP.

4. The SIDWA of claim 1, further comprising a dielectric substate, the substrate having the AS defined therein.

5. The SIDWA of claim 1, wherein:
the IP includes a dielectric material that is at least one of continuous, evenly distributed, and homogeneous; and
the outer layer comprises a same dielectric material as that of the IP, the dielectric material of the outer layer defining a pattern of openings that causes the permittivity of the outer layer to be lower than the permittivity of the IP.

6. The SIDWA of claim 1, wherein:
the IP of the antenna structure includes a dielectric material that is at least one of continuous, evenly distributed, and homogeneous; and
the outer layer comprises a same dielectric material as that of the IP of the antenna structure, the dielectric material of the outer layer defining a plurality of holes that cause the permittivity of the outer layer to be lower than the permittivity of the IP of the antenna structure.

7. The SIDWA of claim 4, wherein the dielectric material includes alumina.

8. The SIDWA of claim 1, wherein the IP defines a flared section wherein at least one the first IP transverse dimension and the second IP transverse dimension increases perpendicularly to a direction from the first IP end to the second IP end.

9. The SIDWA of claim 8, wherein the first transverse dimension and the second transverse dimension define a rectangular waveguiding section.

10. An antenna module, comprising:
a plurality of antenna units, each antenna unit of the plurality of antenna units having:
a substrate-integrated waveguide (SIW) having:
a first SIW end configured to couple to an integrated circuit (IC); and
a second SIW end; and
a substrate-integrated antenna (SIA) having:
a first SIA end coupled to the second SIW end; and
a second SIA end,
wherein at least one of:
the second SIA ends of all the SIAs are in a first common plane, and
the first SIW ends of all the SIWs are in a second common plane.

11. The antenna module of claim 10, wherein:
the SIA of each antenna unit of the plurality of antenna units includes a respective antenna structure (AS), the AS having:
an inner portion (IP) having:
a first permittivity:
a first IP transverse dimension;
a second IP transverse dimension;
a first IP end formed at the first SIA end of the respective SIA; and
a second IP formed at the second SIA end and opposite the first IP end,
the first IP transverse dimension being smaller, at the first IP end, than the first IP transverse dimension at the second IP end; and
the second IP transverse dimension being smaller, at the first IP end, than the second IP transverse dimension at the second IP end;
and
an outer layer having a second permittivity, the second permittivity being less than the first permittivity, the outer layer surrounding the IP of the AS.

12. The antenna module of claim 11, wherein the SIA of an antenna unit of the plurality of antenna units is contiguous to the SIA of at least one different antenna unit of the plurality of antenna units.

13. The antenna module of claim 11, wherein:
the plurality of antenna units comprises of M×N antenna units having associated thereto M×N second SIA ends, M and N being positive integer numbers, and
the M×N second SIA ends are arranged in a matrix, in the first common plane.

14. The antenna module of claim 11, wherein:
the plurality of antenna units comprises of M×N antenna units having associated thereto M×N first SIW ends, M and N being positive integer numbers, and
the M×N first SIW ends are arranged in a matrix, in the second common plane.

15. The antenna module of claim 11, wherein, for each SIA:
the IP of the respective AS includes a dielectric material that is at least one of continuous, evenly distributed, and homogeneous, and
the outer layer of the respective AS comprises a same dielectric material as that of the IP of the AS, the dielectric material of the outer layer defining a plurality of discontinuities causing the permittivity of the second layer to be lower than the permittivity of the antenna structure.

16. The antenna module of claim 11, wherein, for each SIA:
the IP of the respective AS includes a dielectric material that is at least one of continuous, evenly distributed, and homogeneous, and
the outer layer of the respective AS comprises a same dielectric material as that of the IP of the AS, the dielectric material of the outer layer defining a pattern of openings that causes the permittivity of the outer layer to be lower than the permittivity of the inner portion of the antenna structure.

17. The antenna module of claim 11, wherein SIA is one of:
a substrate integrated waveguide antenna (SIWA), the outer layer comprising a metal; and
a substrate integrated dielectric waveguide antenna (SIDWA).

18. A substrate-integrated antenna unit, comprising:
a substrate-integrated dielectric waveguide (SIDW) having a first SIDW end and a second SIDW end, the first SIDW end being configured to couple to an integrated circuit; and
a substrate-integrated dielectric waveguide antenna (SIDWA) having a first SIDWA end and a second SIDWA end, the first SIDWA end being coupled to the second SIDW end, the second SIDWA end being configured to couple to a wave propagating structure;
the SIDWA having a physically patterned substrate portion;
the SIDWA having an un-patterned substrate portion extending from the first SIDWA end toward the second SIDWA end, the un-patterned substrate portion having a flared section;
the physically patterned substrate portion surrounding the un-patterned substrate portion and configured to confine, in the un-patterned substrate portion, an electro-magnetic (EM) signal as the EM signal propagates between the first SIDWA end and the second SIDWA end.

19. The antenna unit of claim 18, wherein a width of the flared section increases in a direction from the first SIDWA end toward the second SIDWA end.
